(19) United States
(12) Patent Application Publication
(10) Pub. No.: US 2015/0346852 A1
(43) Pub. Date: Dec. 3, 2015

(54) OPERATION APPARATUS

(71) Applicant: FUJITSU TEN LIMITED, Kobe-shi (JP)

(72) Inventors: Motoya JIYAMA, Kobe-shi (JP); Minoru MAEHATA, Kobe-shi (JP); Tetsuya KATO, Kobe-shi (JP); Tomoaki ISHIKAWA, Kobe-shi (JP)

(21) Appl. No.: 14/712,174

(22) Filed: May 14, 2015

(30) Foreign Application Priority Data
May 29, 2014 (JP) 2014-110973

(51) Int. Cl. G06F 3/041

(52) U.S. Cl. CPC G06F 3/041

(57) ABSTRACT

An operation panel includes: a surface member that includes a first main surface and a second main surface, the first main surface on which a touch operation is performed, the second main surface facing in a direction opposite to a direction faced by the first main surface; and a touch sensor that is provided along the second main surface of the surface member and that detects a touch operation on the first main surface. The second main surface is a 2D curved surface bent only in a left-right direction and the first main surface is a 3D curved surface bent in two or more directions including the left-right direction. Since the second main surface of the surface member is the 2D curved surface, the touch sensor can be provided along the second main surface.

### BACKGROUND OF THE INVENTION

1. Field of the Invention

The invention relates to a technology that receives a touch operation.

2. Description of the Background Art

Conventionally, an operation apparatus is known that includes a touch panel function that receives a touch operation performed by a user. Such an operation apparatus includes a display having a display screen overlapped with an operation surface on which the user performs the touch operation. The user gives various commands via the operation apparatus by performing touch operations on positions corresponding to images of command buttons and the like displayed on the display screen overlapped with the operation surface.

A well-known structure of such an operation apparatus has a main surface, serving as the operation surface, of a front side of a surface member and also has a touch sensor provided along a main surface of a back side of the surface member. The touch sensor detects the touch operation performed by the user on the operation surface (main surface of the front side of the surface member) of the operation apparatus.

Recently, from an aesthetic aspect and for other reasons, the operation surface of the operation apparatus is often designed to be a complexly curved surface that is bent in two or more directions (hereinafter referred to as “3D curved surface”). Generally, a film-shaped member is used as the touch sensor. Therefore, if the main surface of the back side of the surface member is a complexly curved surface same as the operation surface, the touch sensor cannot be provided along the main surface of the back side.

On the other hand, the main surface of the back side of the surface member may be a flat surface to provide the touch sensor. However, in this case, thickness of the surface member varies, depending on portions of the operation surface. Accordingly, detection sensitivity of detecting the touch operation varies depending on the portions of the operation surface. Therefore, there is a possibility that operability of the operation apparatus is lowered.

### SUMMARY OF THE INVENTION

According to one aspect of the invention, an operation apparatus receives a touch operation. The operation apparatus includes: a surface member that includes a first main surface and a second main surface, the first main surface on which the touch operation is performed, the second main surface facing in a direction opposite to a direction faced by the first main surface; and a touch sensor that is provided along the second main surface of the surface member and that detects the touch operation on the first main surface. The second main surface is a curved surface bent only in a first direction, and the first main surface is a curved surface bent in two or more directions including the first direction.

Even if the first main surface of the surface member is a complex curved surface, the touch sensor can be provided along the second main surface of the surface member. Moreover, a difference in thickness values between portions of the surface member can be reduced. Thus, the difference in the detection sensitivity of the touch sensor of detecting the touch operations performed on the portions of the surface member can be reduced.

According to another aspect of the invention, in a cross-section of the surface member along a line in the first direction, shapes of the first main surface and the second main surface are substantially a same shape.

Therefore, the thickness value of the surface member in the cross-section along the line in the first direction is substantially constant. Thus, the difference in the detection sensitivity of the touch sensor of detecting the touch operations performed on the portions of the surface member can be effectively reduced.

According to another aspect of the invention, the first main surface of the surface member is the curved surface bent in the first direction and in a second direction orthogonal to the first direction. On an assumption that the second main surface of the surface member is a flat surface, a difference in thickness values between portions of the surface member disposed along the line in the first direction is greater than a difference in thickness values between portions of the surface member disposed along a line in the second direction, each of the thickness values being a distance between the first main surface and the second main surface of the surface member.

On the assumption that the second main surface of the surface member is a flat surface, the difference in the thickness values between the portions of the surface member can be reduced in a cross-section along a line in a direction in which the difference in the thickness values between the portions of the surface member is greater. Thus, the difference in the detection sensitivity of the touch sensor of detecting the touch operations performed on the portions of the surface member can be effectively reduced.

Therefore, an object of the invention is to provide a touch sensor along a main surface of a surface member and to reduce a difference in detection sensitivity of the touch sensor of detecting touch operations performed on portions of the surface member.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 illustrates an external appearance of a vehicle-mounted display apparatus;

FIG. 2 illustrates an inside of a cabin of a vehicle in which the vehicle-mounted display apparatus is mounted;

FIG. 3 illustrates an exploded perspective view of a structure of an operation panel;

FIG. 4 illustrates a shape of a surface member;

FIG. 5 illustrates an assembling process of the operation panel;

FIG. 6 illustrates a perspective view of the operation panel in a first embodiment;

FIG. 7 illustrates a cross-sectional view of the operation panel along a line in an up-down direction;

FIG. 8 illustrates a cross-sectional view of the operation panel along a line in a left-right direction;

FIG. 9 illustrates a first comparison example;

FIG. 10 illustrates a second comparison example;

FIG. 11 illustrates a method of bonding a display with the operation panel;

FIG. 12 illustrates the method of bonding the display with the operation panel;

FIG. 13 illustrates the method of bonding the display with the operation panel;

FIG. 14 illustrates a perspective view of an operation panel in a second embodiment;

FIG. 15 illustrates a process of forming a circuit of a touch sensor.

### DESCRIPTION OF THE EMBODIMENTS

Embodiments of the invention will be hereinafter described with reference to the drawings. As an example of an operation apparatus that receives a touch operation of a user, a vehicle-mounted display apparatus that is mounted in a vehicle, such as a car, to be used in a cabin of the vehicle will be described below.

### 1. First Embodiment

<1-1. Outline of Vehicle-Mounted Display Apparatus>

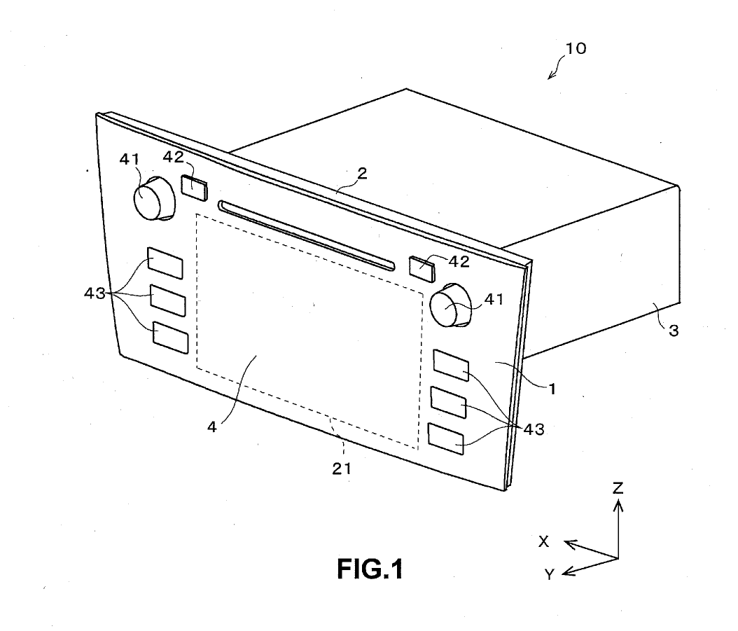

FIG. 1 illustrates an external appearance of a vehicle-mounted display apparatus 10 in this embodiment. The vehicle-mounted display apparatus 10 includes, for example, a navigation function that provides a route guidance leading to a destination and an audio function that outputs sound to the cabin. Moreover, the vehicle-mounted display apparatus 10 includes a touch panel function that receives the touch operation performed by the user (mainly a driver of the vehicle). The user performs the touch operations on an operation surface 4 of the vehicle-mounted display apparatus 10 to give various commands to the vehicle-mounted display apparatus 10. Hereinafter, “front side” means a side of the operation surface 4 of the vehicle-mounted display apparatus 10 in a depth direction of (front-back direction) and “back side” means a side facing in a direction opposite to a direction faced by the operation surface 4.

The vehicle-mounted display apparatus 10 mainly includes an operation panel 1, a display 2 and a main body 3.

The display 2, displays, on a display screen 21, an image for the route guidance and other various images that the user needs. Moreover, the display 2 also displays an icon, a command button and other images that are used for the touch operation (hereinafter referred to as “touch image”), on the display screen 21.

The operation panel 1 includes the operation surface 4 that receives an operation of the user. The operation panel 1 has a transparent member and is provided so as to overlap with a main surface of the front side of the display 2 including the display screen 21. Therefore, the user can see the touch image and other images that are displayed on the display screen 21 of the display 2 through the operation surface 4 of the operation panel 1.

The operation panel 1 includes a function that detects the touch operation performed on the operation surface 4. The operation panel 1 detects the touch operation performed on the touch image displayed on the display screen 21 and also detects the touch operation performed on a button 43 that is provided to the operation panel 1. Moreover, physical buttons 41 and 42 that receive an operation performed by the user are provided to an upper portion of the operation surface 4 of the operation panel 1. The user can give the various commands to the vehicle-mounted display apparatus 10, using these buttons 41, 42 and 43 and the touch images displayed on the display screen 21.

A controller that comprehensively controls the vehicle-mounted display apparatus 10 is embedded in the main body 3. The controller sends an image signal to the display 2 and causes the display 2 to display the various images on the display screen 21. Moreover, the controller controls each function and part of the vehicle-mounted display apparatus 10 to work based on the operation of the user received by the operation panel 1.

A 3D Cartesian coordinate in the drawings is used for the explanation below to properly show directions and orientations. The Cartesian coordinate is fixed relative to the vehicle-mounted display apparatus 10. An X-axis direction represents a left-right direction, a Y-axis direction represents the depth direction and a Z-axis direction represents an up-down direction. A left side of the display screen 21 is referred to as +X side. A right side of the display screen 21 is referred to as −X side. Moreover, the front side is referred to as +Y side and the back side is referred to as −Y side. An upper side is +Z side and a lower side is −Z side.

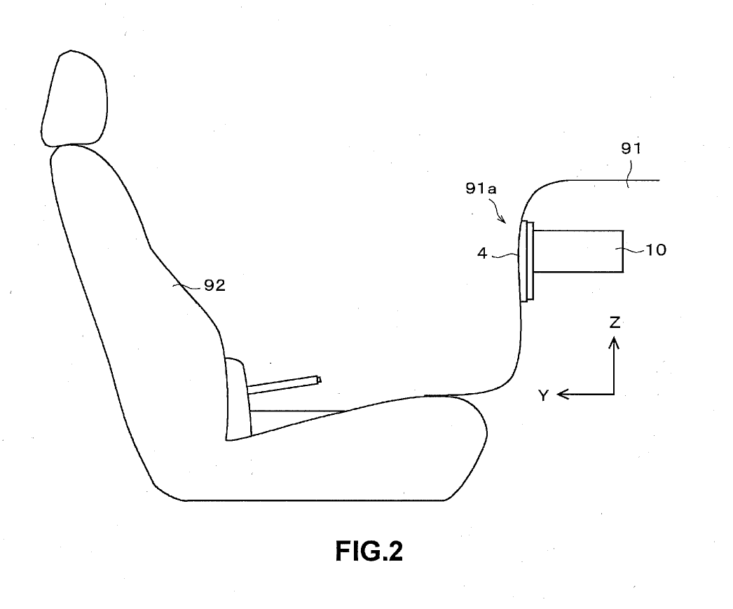

FIG. 2 illustrates an inside of the cabin of the vehicle in which the vehicle-mounted display apparatus 10 is mounted. A right side of FIG. 2 is a front side of the vehicle. As shown in FIG. 2, the vehicle-mounted display apparatus 10 is mounted in a center console 91, part of interior of the vehicle, but the operation surface 4 of the vehicle-mounted display apparatus 10 is uncovered to receive the operation of the user. The user in a seat 92 of the vehicle uses the vehicle-mounted display apparatus 10 mounted in the center console 91.

From an aesthetic aspect and for other reasons, a panel surface 91a of the center console 91 facing the user is a smoothly curved surface as a whole. The operation surface 4 of the vehicle-mounted display apparatus 10 is a curved surface designed to be a part of the panel surface 91a.

<1-2. Outline of Operation Panel>

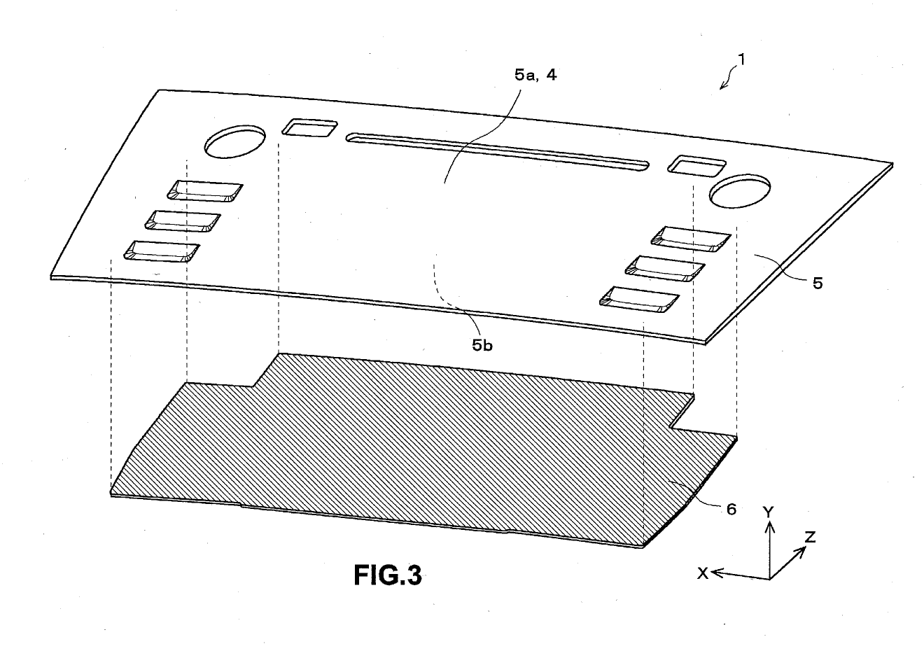

The operation panel 1 having the operation surface 4 curved as mentioned above will be described below. FIG. 3 illustrates an exploded perspective view of the operation panel 1, showing a structure of the operation panel 1. As shown in FIG. 3, the operation panel 1 mainly includes a surface member 5 and a touch sensor 6.

The surface member 5 is an optically transparent covering member, such as glass and plastics, and is also called “overlay.” The surface member 5 includes a first main surface 5a and a second main surface 5b, a surface facing in a direction opposite to a direction faced by the first main surface 5a. The first main surface 5a of the front side (+Y side) of the surface member 5 functions as the operation surface 4 of the vehicle-mounted display apparatus 10 and the user performs the touch operation on the first main surface 5a.

Moreover, the touch sensor 6 employs a capacitance method of detecting capacitance as a detection method of the touch operation. The touch sensor 6 is a sensor that detects a touched position of the touch operation of the user, based on a change in the capacitance. The touch sensor 6 provided to the second main surface 5b of the back side (−Y side) of the surface member 5 detects the touch operation on the first main surface 5a (i.e. the operation surface 4) of the front side of the surface member 5. The touch sensor 6 is provided so as to cover a region corresponding to the display screen 21 on the operation surface 4 and also a region corresponding to the buttons 43 (refer to FIG. 1). Therefore, the touch sensor 6 detects the touch operations performed on both of the display screen 21 and the buttons 43.

Before being provided to the second main surface 5b, the touch sensor 6 is an optically transparent film-shaped (sheet-shaped) material that is transparent and bendable freely. The touch sensor 6 is disposed, in a bent state, along the second main surface 5b of the back side (−Y side) of the surface member 5 (details will be described later).

<1-3. Shape of Surface Member>

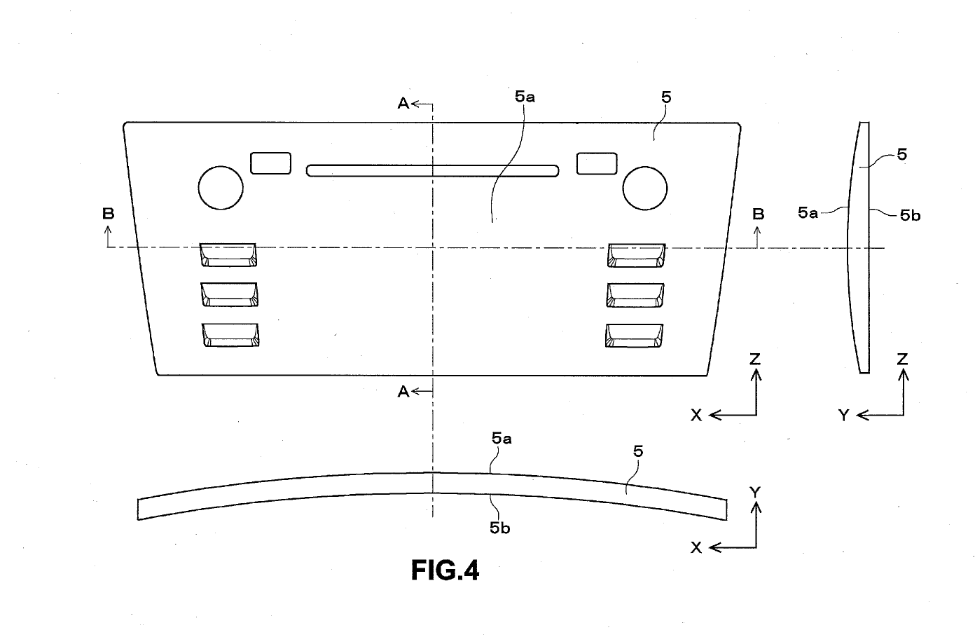

Next a shape of the surface member 5 will be described in more detail. FIG. 4 illustrates the shape of the surface member 5. FIG. 4 illustrates two cross-sectional views of the surface member 5 in addition to a front elevation of the surface member 5 viewed from the front side (+Y side). A drawing on a right side (right drawing) of FIG. 4 is the cross-sectional view of the surface member 5 along a line A to A in the up-down direction (Z-axis direction) of the front elevation. A drawing on a lower side (lower drawing) of FIG. 4 is the cross-sectional view of the surface member 5 along a line B to B in the left-right direction (X-axis direction) of the front elevation.

In the cross-sectional views (also in the drawings referenced later), a curvature of the curved surface and a thickness in the depth direction (Y-axis direction) are illustrated exaggeratingly as compared to an actual curvature and an actual thickness of the curved surface, for easy understanding of the shapes of the surface member 5 and the like.

Moreover, in the explanation below, “3D curved surface” means a curved surface bent in two or more directions that are different from one another, and “2D curved surface” means a curved surface bent only in one direction. The 3D curved surface is a relatively complex curved surface, such as a surface of a sphere, that cannot be generated by bending a flat surface. On the other hand, the 2D curved surface is a relatively simple curved surface, such as a surface of a cylinder, that can be generated by bending a flat surface.

As shown in FIG. 4, the first main surface 5a of the surface member 5, serving as the operation surface 4, is the 3D curved surface bent in the up-down direction (Z-axis direction) and also in the left-right direction (X-axis direction). As shown in the right drawing of FIG. 4, the first main surface 5a of the surface member 5 is bent forward (+Y side) into a convex shape like an arc in the up-down direction (Z-axis direction). A curvature radius of the first main surface 5a is, for example, 1600 mm. As shown in the lower drawing of FIG. 4, the first main surface 5a of the surface member 5 is bent forward (+Y side) into a convex shape like an arc in the left-right direction (X-axis direction). A curvature radius of the first main surface 5a is, for example, 3000 mm.

On the other hand, the second main surface 5b of the surface member 5 is the 2D curved surface that is bent only in the left-right direction (X-axis direction). As shown in the right drawing of FIG. 4, the second main surface 5b of the surface member 5 is not bent but is linear in the up-down direction (Z-axis direction). However, as shown in the lower drawing of FIG. 4, the second main surface 5b of the surface member 5 is bent forward (+Y side) into a convex shape in the left-right direction (X-axis direction).

Thus, as shown in the right drawing of FIG. 4, in a cross-section of the surface member 5 disposed along the line in the up-down direction (Z-axis direction), the shapes of the first main surface 5a and the second main surface 5b are different from each other. A cross-sectional shape of the surface member 5 shown in the right drawing is a semicylindrical shape or a vault-like shape (a shape having two sides facing each other of which one side is curved and the other is linear). On the other hand, as shown in the lower drawing of FIG. 4, in a cross-section of the surface member 5 disposed along the line in the left-right direction (X-axis direction), the shapes of the first main surface 5a and the second main surface 5b are substantially a same shape.

The touch sensor 6, the film-shaped member, cannot be formed into a 3D curved surface. Therefore, if the second main surface 5b of the surface member 5 is the 3D curved surface same as the first main surface 5a, the touch sensor 6 cannot be provided along the second main surface 5b of the surface member 5. However, the second main surface 5b of the surface member 5 in this embodiment is the 2D curved surface. Since the touch sensor 6 can be formed into the 2D curved surface substantially same as the second main surface 5b of the surface member 5, the touch sensor 6 can be provided along the second main surface 5b of the surface member 5.

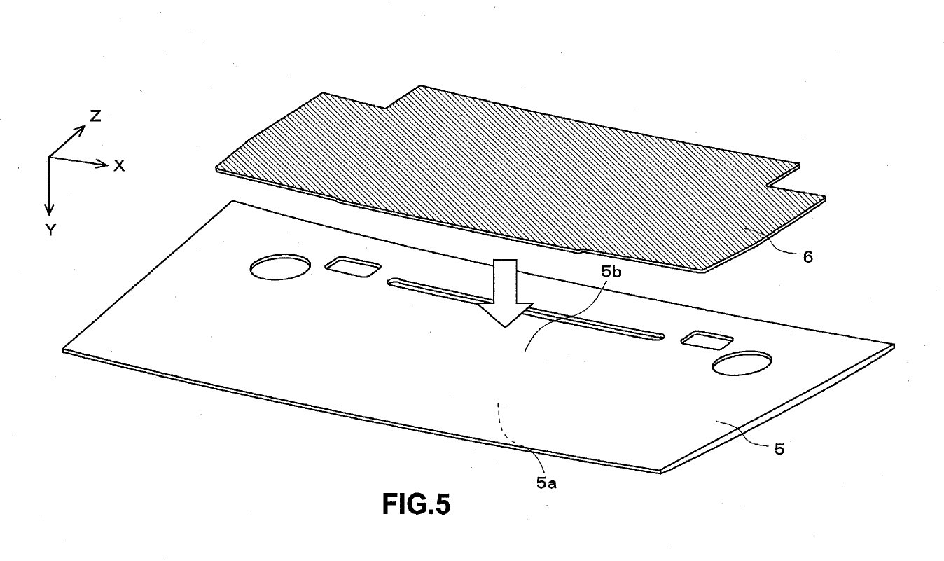

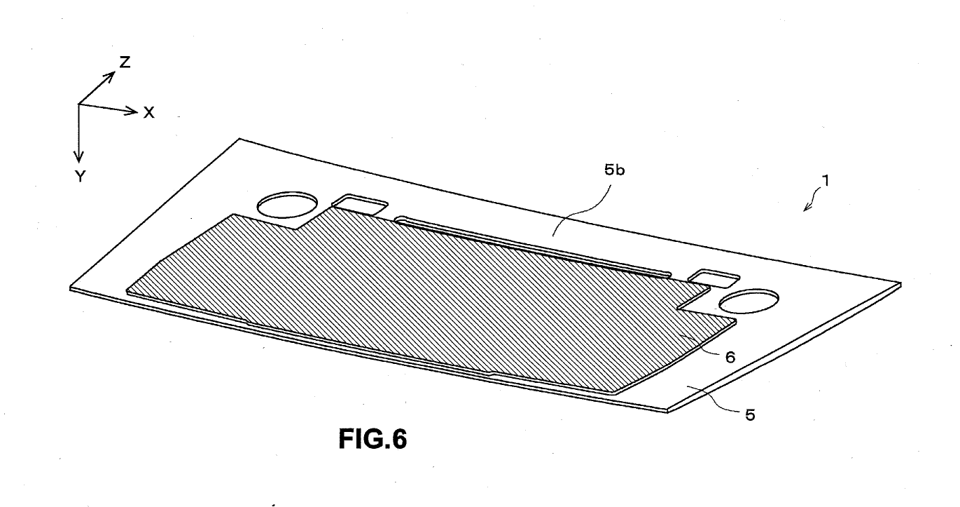

As shown in FIG. 5, in an assembling process of the operation panel 1, the touch sensor 6, the film-shaped member, is bent forward (+Y side) into the convex shape in the left-right direction (X-axis direction). Therefore, the touch sensor 6 is formed into the 2D curved surface substantially same as the second main surface 5b of the back side (−Y side) of the surface member 5. Then, the formed touch sensor 6 is bonded to the second main surface 5b of the surface member 5 with adhesive, such as optical clear resin (OCR) and optical clear adhesive (OCA). Thus, as shown in FIG. 6, the operation panel 1 includes the touch sensor 6 provided along the second main surface 5b of the surface member 5.

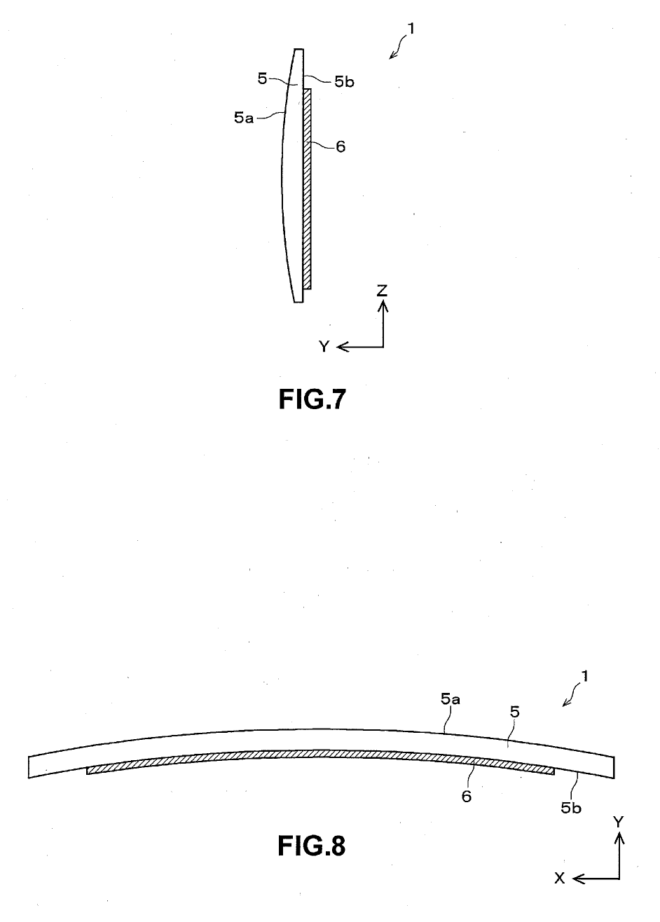

FIG. 7 illustrates a cross-sectional view of the operation panel 1 along a line in the up-down direction (Z-axis direction) equivalent to the line A to A in FIG. 4. FIG. 8 illustrates a cross-sectional view of the operation panel 1 along a line in the left-right direction (X-axis direction) equivalent to the line B to B in FIG. 4. As shown in those drawings, the touch sensor 6 formed into the 2D curved surface is closely bonded to and provided along the second main surface 5b of the surface member 5 without a gap.

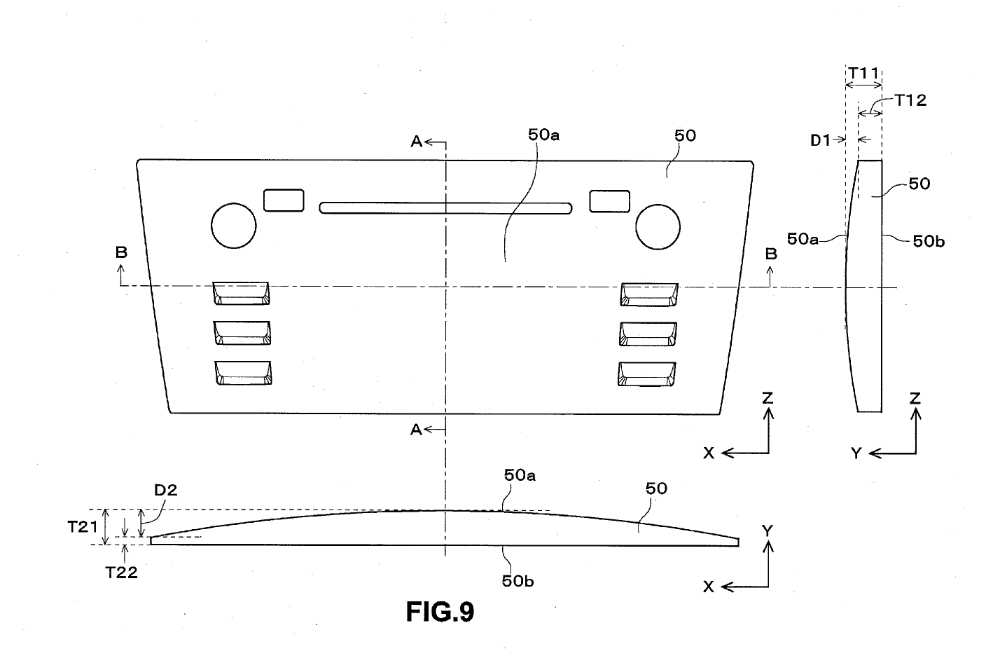

However, a different form is possible in which a second main surface of a surface member is formed into a flat surface and the touch sensor 6 is bonded along the flat second main surface. FIG. 9 illustrates the foregoing form of a surface member 50, a first comparison example. Like FIG. 4, FIG. 9 illustrates two cross-sectional views of the surface member 50 in addition to a front elevation of the surface member 50 viewed from the front side (+Y side). A distance between a first main surface and the second main surface of the surface member in the depth direction (Y-axis direction) are hereinafter referred to as “thickness value” of the surface member.

A first main surface 50a of the surface member 50 of the first comparison example is a 3D curved surface same as the surface member 5 (refer to FIG. 4) of the first embodiment. However, a second main surface 50b of the surface member 50 is a flat surface. Thus, cross-sectional shapes of the surface member 50 disposed along a line in the up-down direction (Z-axis direction) and along a line in the left-right direction (X-axis direction) are both vault-like shapes. Therefore, a relatively great difference (variation) in “thickness” values is caused between portions of the surface member 50. A greatest “thickness” value and a smallest “thickness” value of the surface member 50 of the first comparison example are, for example, 5.5 mm and 2 mm, respectively.

Since the touch sensor 6 is provided along the second main surface, the thickness value of the surface member affects detection sensitivity of the touch sensor 6 that detects the touch operation on the first main surface of the surface member. Therefore, a relatively great difference (variation) in the detection sensitivity of the touch sensor 6 is caused between the portions of the surface member 50 of the first comparison example. As a result, in a case where the surface member 50 of the first comparison example is used, there is a possibility that operability of the vehicle-mounted display apparatus 10 is lowered.

On the other hand, the surface member 5 (refer to FIG. 4) in this embodiment, the second main surface 5b is the curved surface bent in the left-right direction (X-axis direction) and the shapes of the first main surface 5a and the second main surface 5b are substantially the same shape in the cross-section of the surface member 5 disposed along the line in the left-right direction (X-axis direction). Therefore, no difference in the “thickness” values is caused between portions of the surface member 5 in the cross-section of the surface member 5 disposed along the line in the left-right direction and the “thickness” value of the surface member 5 is substantially constant.

Thus, the difference (variation) in the “thickness” values caused between portions of the surface member 5 as a whole can be reduced. A greatest “thickness” value and a smallest “thickness” value of the surface member 5 in this embodiment are, for example, 3 mm and 2 mm, respectively. As a result, the difference (variation) in detection sensitivity of the touch sensor 6 caused between the portions of the surface member 5 can be reduced and thus the operability of the vehicle-mounted display apparatus 10 can be improved.

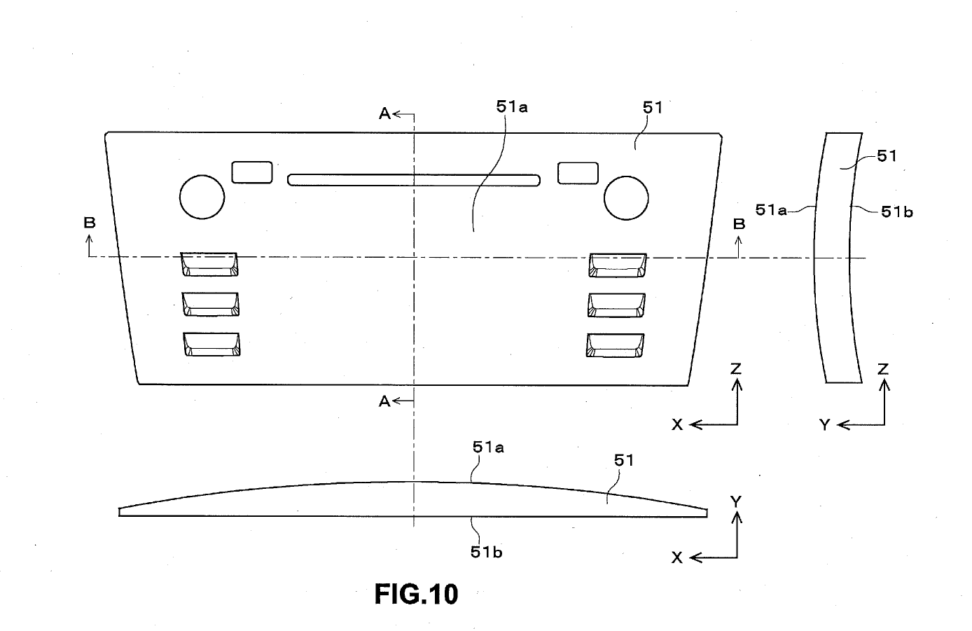

Moreover, a form is also possible in which a second main surface of a surface member is a 2D curved surface bent only in the up-down direction (Z-axis direction), not in the left-right direction (X-axis direction). FIG. 10 illustrates the foregoing form of a surface member 51, a second comparison example. Like FIG. 4, FIG. 10 illustrates two cross-sectional views of the surface member 51 in addition to a front elevation of the surface member 51 viewed from the front side (+Y side).

A first main surface 51a of the surface member 51 of the second comparison example is a 3D curved surface same as the surface member 5 (refer to FIG. 4) of the first embodiment. On the other hand, as shown in a lower drawing of FIG. 10, a second main surface 51b of the surface member 51 is not bent in the left-right direction (X-axis direction) but is linear in the left-right direction (X-axis direction). Moreover, as shown in a right drawing of FIG. 10, the second main surface 51b of the surface member 51 is bent forward (+Y side) into a convex shape like an arc in the up-down direction (Z-axis direction). Thus, in the cross-section of the surface member 51 disposed along a line in the up-down direction (Z-axis direction), the shapes of the first main surface 51a and the second main surface 51b are substantially a same shape.

A difference (variation) in “thickness” values between the portions of the surface member 51 of the second comparison example described above can be reduced to some extent. However, the difference in the “thickness” values between the portions of the surface member 5 (refer to FIG. 4) in the first embodiment is more reduced than the difference in the “thickness” values between the portions of the surface member 51 of the second comparison example.

On an assumption that the second main surface is a flat surface, when a case where the second main surface is bent in the up-down direction (Z-axis direction) into a same curve as the first main surface is compared with a case where the second main surface is bent in the left-right direction (X-axis direction) into a same curve, as the first mains surface, the difference in the “thickness” values between the portions of the surface member 5 can be more effectively reduced by bending the second main surface in one of those directions in which the difference in the “thickness” values between the portions of the surface member 5 is greater.

The form shown in FIG. 9 is equivalent to the assumption that the second main surface is the flat surface. On the assumption that the second main surface is the flat surface, as shown in FIG. 9, the cross section of the surface member disposed along the line in the up-down direction (Z-axis direction) has a greatest “thickness” value T11 and a smallest “thickness” value T12. A difference D1 that is the difference in the “thickness” values between the portions of the cross section is obtained by subtracting T12 from T11. The cross section of the surface member disposed along the line in the left-right direction (X-axis direction) has a greatest “thickness” value T21 and a smallest “thickness” value T22. A difference D2 that is the difference in the “thickness” values between the portions of the cross section is obtained by subtracting T22 from T21.

The difference D2 in the “thickness” values between the portions in the cross section disposed along the line in the left-right direction (X-axis direction) is greater than the difference D1 in the “thickness” values between the portions in the cross section disposed along the line in the up-down direction (Z-axis direction). Thus, the difference in the “thickness” values between the portions of the surface member 5, can be more effectively reduced by bending the second main surface in the left-right direction (X-axis direction) than by bending the second main surface in the up-down direction (Z-axis direction).

The second main surface 5b of the surface member 5 (refer to FIG. 4) in this embodiment is the curved surface bent only in the left-right direction (X-axis direction). Therefore, the difference in the “thickness” values between the portions of the surface member 5 is reduced more effectively. Thus, the difference (variation) in detection sensitivity of the touch sensor 6 caused between the portions of the surface member 5 can be more effectively reduced.

In the explanation above, the thickness values of the entire surface member 5 are examined for simple explanation. However, it is better to examine the thickness values only of the region of the surface member to which the touch sensor 6 is provided.

<1-4. Bonding of Operation Panel and Display>

As described above, the operation panel 1 is assembled by bonding the surface member 5 with the touch sensor 6. The surface of the back side (−Y side) of the operation panel 1 to which the touch sensor 6 is provided is the 2D curved surface. In an assembling process of the vehicle-mounted display apparatus 10, the display 2 including the flat display screen 21 needs to be bonded with the surface of the back side (−Y side) of the operation panel 1 that is the 2D curved surface. A method of bonding the display 2 with the operation panel 1 will be explained below.

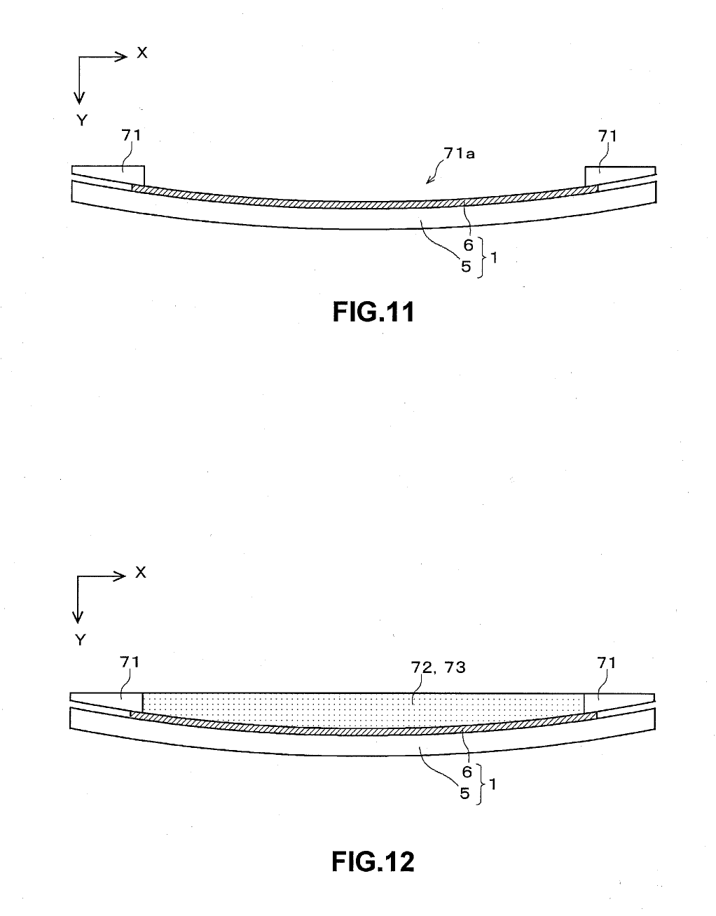

First, as shown in FIG. 11, a frame 71 is bonded to the surface of the back side (−Y side) of the operation panel 1 by using, for example, OCR. The frame 71 is a frame member that has an opening 71a in a center of the frame 71 in the depth direction (Y-axis direction). Since the frame 71 is bonded to the operation panel 1, the opening 71a is surrounded by the operation panel 1 and the frame 71 and thus the opening 71a serves as a space, like a container, that can hold liquid.

Next, as shown in FIG. 12, liquid OCR 72 is poured into the opening 71a of the frame 71 by a dispenser or another device. The liquid OCR 72 is poured into the opening 71a so as to fully fill the entire opening 71a. Next, the opening 71a is irradiated with ultraviolet ray from two sides of the depth direction (Y-axis direction) to harden the OCR 72 filling the opening 71a of the frame 71. As a result, an optically-transparent resin object 73 is formed in the opening 71a of the frame 71. A surface of a back side (−Y side) of the resin object 73 is a flat surface.

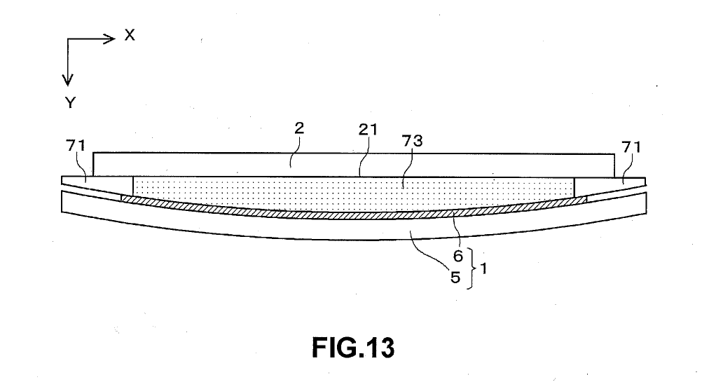

Next, as shown in FIG. 13, the display 2 is bonded to the surface of the back side (−Y side) of the resin object 73, by using, for example, OCR. The display 2 is bonded to the surface of the back side of the resin object 73 such that the display screen 21 of the display 2 faces the surface of the back side (−Y side) of the resin object 73. Since the surface of the back side (−Y side) of the resin object 73 is the flat surface, the flat display screen 21 of the display 2 is easily bonded to the surface of the back side (−Y side) of the resin object 73.

As described above, the operation panel 1 in this embodiment includes the touch sensor 6 and the surface member 5 that has the first main surface 5a and the second main surface 5b. The touch operation is performed on the first main surface 5a and the second main surface 5b is the side facing in a direction opposite to a direction faced by the first main surface 5a. The touch sensor 6 is provided along the second main surface 5b and detects the touch operation on the first main surface 5a. The second main surface 5b of the surface member 5 is the 2D curved surface bent only in the left-right direction (X-axis direction) but the first main surface 5a is the 3D curved surface bent in two or more directions including the left-right direction (X-axis direction).

Since the second main surface 5b of the surface member 5 is the 2D curved surface, even if the first main surface 5a of the surface member 5 is the complex 3D curved surface, the touch sensor 6 can be provided along the second main surface 5b of the surface member 5. Moreover, the difference in the “thickness” values between the portions of the surface member 5 in the cross section disposed along the line in the left-right direction (X-axis direction) can be reduced. Thus, the difference in the detection sensitivity of the touch sensor 6 of detecting the touch operations performed on the portions of the surface member 5 can be reduced.

Moreover, in the cross-section of the surface member 5 disposed along the line in the left-right direction (X-axis direction), the shapes of the first main surface 5a and the second main surface 5b are substantially the same shape. Therefore, the “thickness” value of the surface member 5 in the cross-section disposed along the line in the left-right direction (X-axis direction) is substantially constant. Thus, the difference in the detection sensitivity of the touch sensor 6 of detecting the touch operations performed on the portions of the surface member 5 can be effectively reduced.

Moreover, the first main surface 5a of the surface member 5 is the curved surface bent in the left-right direction (X-axis direction) and in the up-down direction (Z-axis direction) orthogonal to the left-right direction (X-axis direction). On an assumption that the second main surface 5b of the surface member 5 is a flat surface, a difference in the “thickness” value between the first main surface 5a and the second main surface 5b in the cross section of the surface member 5 disposed along the line in the left-right direction (X-axis direction) is greater than a difference in the “thickness” value between the first main surface 5a and the second main surface 5b in the cross section of the surface member 5 disposed along the line in the up-down direction (Z-axis direction).

Therefore, on the assumption that the second main surface 5b is a flat surface, the difference in the “thickness” values can be reduced in a cross-section along a line in a direction in which the difference in the “thickness” values between the portions of the surface member 5 is greater. Therefore, the difference in the detection sensitivity of the touch sensor 6 of detecting the touch operations performed on the portions can be reduced effectively.

### 2. Second Embodiment

Next, a second embodiment is described. A configuration of a vehicle-mounted display apparatus 10 in the second embodiment is substantially the same as the configuration of the vehicle-mounted display apparatus 10 in the first embodiment. Therefore, differences from the first embodiment are mainly described below.

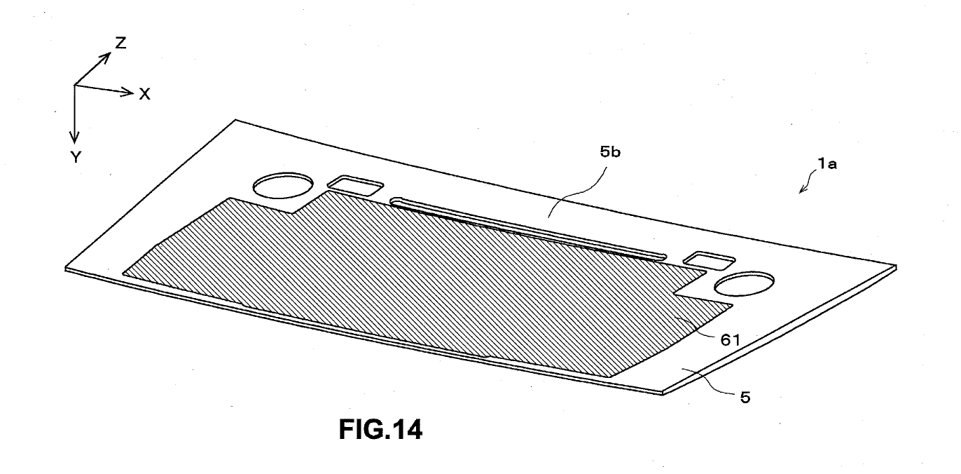

FIG. 14 illustrates a perspective view of a surface of a back side of an operation panel 1a in the second embodiment. As shown in FIG. 14, a touch sensor 61 is also provided along a second main surface 5b of a back side (−Y side) of a surface member 5 of the operation panel 1a in the second embodiment. However, a forming method of the touch sensor 61 is different from the method in the first embodiment. In the first embodiment, the touch sensor 6 is the bent film-shaped member. On the other hand, in the second embodiment, the touch sensor 61 is printed on the second main surface 5b of the surface member 5.

A shape of the surface member 5 is the same as the shape of the surface member 5 in the first embodiment. Therefore, the second main surface 5b of the surface member 5 is a 2D curved surface bent only in a left-right direction (X-axis direction). Therefore, a circuit (pattern) of the touch sensor 61 can be formed by employing a well-known printing method that uses a printing plate and a squeegee (e.g. silk screen printing), a printing roller or the like. The circuit of the touch sensor 61 includes, for example, a silver nanowire or a carbon nanotube.

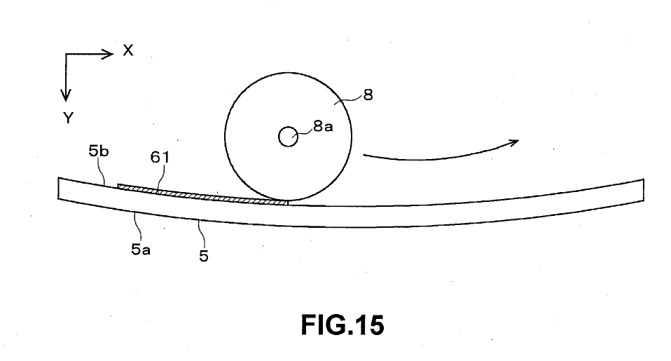

FIG. 15 illustrates a process of forming the circuit of the touch sensor 61 on the second main surface 5b of the surface member 5 by using a printing roller 8. The second main surface 5b of the surface member 5 is bent in the left-right direction (X-axis direction), but is linear in the up-down direction (Z-axis direction). Therefore, as shown in FIG. 15, a shaft 8a of the printing roller 8 is moved in the up-down direction (Z-axis direction) to cause the printing roller 8 to come into contact with the second main surface 5b of the surface member 5. Then the printing roller 8 can be moved in the left-right direction (X-axis direction), maintaining in contact with the second main surface 5b of the surface member 5. Thus, the touch sensor 61 is formed on the second main surface 5b of the surface member 5.

Even in a case where the circuit of the touch sensor is formed by printing on a 3D curved second main surface of the surface member, it is technologically possible to form the touch sensor on the second main surface. However, in this case, it is necessary to employ a relatively complex printing method, such as an ink-jet method in which a print head can move in three axes. In this case, a manufacturing cost is increased and there is a possibility that a yield percentage will be decreased.

On the other hand, in this embodiment, the second main surface 5b of the surface member 5 on which the circuit is printed is the 2D curved surface. Therefore, a relatively simple printing method can be employed. Therefore, the manufacturing cost is reduced and the yield percentage can be improved.

<3. Modifications>

The embodiments of the invention are described above. However, the invention is not limited to the foregoing embodiments but various modifications are possible. Such modifications are described below. Two or more of all forms of the foregoing embodiments and the modifications below can be arbitrarily combined.

The left-right direction and the up-down direction in the foregoing embodiments may be interchanged.

In the foregoing embodiments, the first main surface 5a of the surface member 5 that serves as the operation surface 4 is the 3D curved surface bent in two directions, the up-down and left-right directions. However, the first main surface 5a of the surface member 5 may be a 3D curved surface bent in three or more directions. In this case, the second main surface 5b of the surface member 5 may be bent in any one of those three or more directions in which the first main surface 5a of the surface member 5 is bent.

In the foregoing embodiments, the main surface of the surface member 5 is bent like an arc. However, a main surface may be bent in a different shape, such as an S-shape.

In the second embodiment, the touch sensor 61 is formed on the second main surface 5b of the surface member 5. However, the touch sensor 61 may be formed by printing on a surface of a front side (+Y side) of a 2D curved transparent member that is closely bonded to and provided along the second main surface 5b of the surface member 5 without a gap.

In the foregoing embodiments, the operation apparatus is described as a vehicle-mounted display apparatus that is mounted on a vehicle, such as a car. However, the operation apparatus may be an operation apparatus that is used at home, in shops, offices factories and places, other than in vehicle. Moreover, the operation apparatus may be a portable apparatus, such as a smartphone and a tablet terminal.

While the invention has been shown and described in detail, the foregoing description is in all aspects illustrative and not restrictive. It is therefore understood that numerous other modifications and variations can be devised without departing from the scope of the invention.

What is claimed is:

1. An operation apparatus that receives a touch operation, the operation apparatus comprising:
a surface member that includes a first main surface and a second main surface, the first main surface on which the touch operation is performed, the second main surface facing in a direction opposite to a direction faced by the first main surface; and
a touch sensor that is provided along the second main surface of the surface member and that detects the touch operation on the first main surface, wherein
the second main surface is a curved surface bent only in a first direction, and
the first main surface is a curved surface bent in two or more directions including the first direction.

2. The operation apparatus according to claim 1, wherein
in a cross-section of the surface member along a line in the first direction, shapes of the first main surface and the second main surface are substantially a same shape.

3. The operation apparatus according to claim 1, wherein
the first main surface of the surface member is the curved surface bent in the first direction and in a second direction orthogonal to the first direction, and
on an assumption that the second main surface of the surface member is a flat surface, a difference in thickness values between portions of the surface member disposed along the line in the first direction is greater than a difference in thickness values between portions of the surface member disposed along a line in the second direction, each of the thickness values being a distance between the first main surface and the second main surface of the surface member.

4. The operation apparatus according to claim 1, wherein
the touch sensor is a film-shaped member bent in the first direction.

5. The operation apparatus according to claim 1, wherein
the touch sensor is printed on the second main surface.

6. The operation apparatus according to claim 1, further comprising:
a display that displays an image that is used for the touch operation, the surface member being disposed over the display.

7. The operation apparatus according to claim 1, wherein
the first surface is a three-dimensional surface, and the second surface is a two dimensional surface.
